(19) United States
(12) Patent Application Publication
(10) Pub. No.: US 2008/0041972 A1
(43) Pub. Date: Feb. 21, 2008

(54) Spraying structure for an atomizer

(75) Inventors: Wen-Pin Chen, Taipei (TW); Nai-Ying Jean, Taipei (TW)

Correspondence Address: TROXELL LAW OFFICE PLLC;SUITE 1404, 5205 LEESBURG PIKE, FALLS CHURCH, VA, 22041, US

(73) Assignee: Kai Chih Industrial Co., Ltd.

(21) Appl. No.: 11/497,420

(22) Filed: Aug. 2, 2006

(51) Int. Cl. B05B 1/08

(52) U.S. Cl. 239/102.2; 239/103; 239/120

(57) ABSTRACT

A spraying structure for an atomizer includes a main body, an interior of which is provided with a vertically installed liquid container with its opening facing upward, and with a liquid delivery member being located above the container for sucking out the liquid; a power part; and a spraying device. The main body can be provided with the spraying device which takes required power from the power part, and is provided with an actuator to operate a vibratory plate. The vibratory plate is configured slantingly with respect to an end head of the liquid delivery member. Through an action to the vibratory plate by the actuator, liquid in a membrane shape on a surface of the liquid delivery member can be atomized to be sprayed out in a tilted direction, thereby achieving a function of spraying laterally.

### BACKGROUND OF THE INVENTION

(a) Field of the Invention

The present invention relates to a spraying structure for an atomizer, and more particularly to a spraying structure which provides a high frequency vibration to actuate mists such that they can be sprayed laterally with respect to a main body eventually, and which enables a residual liquid from an operation to be further returned back to a container.

(b) Description of the Prior Art

It is known that a method of transforming liquid into mists for spraying by a vibration principle has been widely used for scattering medicines or aromatics. In general, a piezoelectric ceramic actuator is primarily used to drive a vibratory plate, a surface of which is provided with actuation holes, such that by a small vibration in high frequency, a surface of liquid can be disintegrated to form an oriented actuation into molecules of mists in small droplets. In addition, through an effect of Brownian motion, fragrances can be mixed into air to change properties of the air, or medicine mists can be created for treatment through inhaling.

Related prior arts include the Japanese patent publication H08-52193, or the Taiwan New Patent publications 523302, 510827, 510826, and 200418713 applied by S.C. Johnson & Son, Inc.

In order to allow the vibratory plate to effectively actuate the mists, those patents use a piece of piezoelectric ceramic 10 in a disk shape (as shown in FIG. 1), and an end surface of which is connected to and is driving a vibratory plate 11. A surface of the vibratory plate 11 is provided with tiny actuation holes (not shown in the drawing), and an actuation surface of the vibratory plate 11 is in contact with a liquid delivery member 12 (such as a liquid absorption fiber) which adsorbs upward the liquid in an interior of a container 13. Through a high frequency vibration wave created when the vibratory plate 11 is driven, a liquid membrane accumulated on a surface of the liquid delivery member 12 can be atomized.

However, these kinds of facilities which actuate mists upward in a vertical direction are provided with many problems in usage. For example, when the liquid absorbed by the liquid delivery member 12 cannot be actuated in time, the excessive liquid will be overflowing to an exterior of the container 13 following the surface of liquid delivery member 12, to stain the container 13 and a usage part (such as a desktop), thereby causing a loss of the liquid. On the other hand, when the vibratory plate 11 is vibrating to actuate the mists, a precipitation may occur at an upper surface of a structural indentation part of the vibratory plate 11 due to a possible agglomeration of the liquid and instability of actuation power. Furthermore, after a first actuation, some mist droplets will not have a uniform diameter or will be enlarged from combination to be sunk back to the container, due to an aperture of very fine holes and operational frequency, which allows the mists to be precipitated on the surface of vibratory plate 11 from the excessive liquid, during a second actuation, thereby causing a loss of driving energy and an incomplete actuation of mists. When the aforementioned structure is an off time, the liquid will be sucked to be attached upward due to a capillary effect resulting from the liquid delivery member 12 itself or from an interaction of the liquid delivery member 12 with the contact surface of vibratory plate 11, and then it will be dripped downward after being accumulated to a certain mass.

Although in the Japanese patent publication H08-52193, a tilted board is added to guide the mists to spray in a tilted direction, the tilted board will cause a structural impedance to the mists such that an appearance and spraying direction will be limited, and as the mists are accumulated on a surface of the tilted board to be dripped back to an interior of the machine or on the vibratory plate 11, the function of vibratory plate 11 will be reduced. In addition, when the machine is in off times, the liquid in an upper container will be seeped down along the tilted board.

In practice, to overcome the aforementioned problems of conventional vertical mists spraying devices, most of the vendors focus on the improvement of functions of the actuation holes of vibratory plates, and actuators. However, as the effect of atomization will also be affected by inherent physical properties of the liquid delivery members, and the mists can be only provided vertically to a space above, a driving by fan will be needed to change a direction of scattering if the mists are to be sprayed to the ambient space.

Moreover, in order to have a function that the mists can be sprayed laterally, as shown in FIG. 2, a container 20 is designed to be laid down and transversally connected with a liquid delivery member 21. The container 20 and the liquid delivery member 21 are also loosely pivoted, enabling an opening to be constantly opened. In addition, due to a constant suction from a capillary effect of the liquid delivery member 21 and gravitational force, the leakage will be even more severe, and the mists will be very quickly precipitated on a desktop 22. Therefore, the opening of aforementioned container 20 should be kept upright.

### SUMMARY OF THE INVENTION

The primary object of present invention is to provide a spraying structure for an atomizer, wherein the actuated mists can be sprayed in a tilted direction, can be further sprayed laterally, and possible residual liquid from multiple external factors after spraying can be recovered in a container.

Another object of the present invention is to provide a spraying structure for an atomizer, wherein a vibratory plate is configured slantingly with respect to a liquid delivery member, and through the slant configuration of vibratory plate, the mists sprayed will be moving in a parabolic curve, thereby being sprayed laterally, eventually.

Yet another object of the present invention is to provide a spraying structure for an atomizer, wherein due to the slant configuration of vibratory plate, the mists can be prevented from being agglomerated and returned back vertically, and the actuation holes of vibratory plate can be prevented from being precipitated by the returned mists in an off or on time, such that the actuation holes can be kept at an optimal condition of aperture. In addition, the droplets of mists can be kept uniformly miniaturized, and a lifetime of usage can be extended correspondingly.

Still another object of the present invention is to provide a spraying structure for an atomizer, wherein an end of the vibratory plate is surrounded by a recovery device which can intercept the mists. In addition to recovering the liquid which is returned back along the vibratory plate, the recovery device can also recover the excessive liquid which cannot be actuated on a surface of the liquid delivery member immediately.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional mist spraying device which sprays the mists vertically.

FIG. 2 shows a schematic view of a conventional mist spraying device which sprays the mists horizontally.

FIG. 3 shows a cutaway view of an assembly of the present invention.

FIG. 4 shows a schematic view of an embodient of the present invention.

FIG. 5 shows a first schematic view of a vibratory plate which is in contact with a liquid delivery member of the present invention.

FIG. 6 shows a second schematic view of a vibratory plate which is in contact with a liquid delivery member of the present invention.

FIG. 7 shows a schematic view of another embodient of a liquid delivery member of the present invention.

FIG. 8 shows a third schematic view of a vibratory plate which is in contact with a liquid delivery member of the present invention.

FIG. 9 shows a schematic view of still another embodient of a liquid delivery member of the present invention.

FIG. 10 shows a side view of an embodient of indirect diversion of liquid of the present invention.

FIG. 11 shows a schematic view of a first of further embodient of an indirect diversion of liquid of the present invention.

FIG. 12 shows a schematic view of a second of further embodient of an indirect diversion of liquid of the present invention.

FIG. 13 shows a schematic view of a third of embodient of an indirect diversion of liquid of the present invention.

FIG. 14 shows a schematic view of a fourth of embodient of an indirect diversion of liquid of the present invention.

FIG. 15 shows a schematic view of a fifth of embodient of an indirect diversion of liquid of the present invention.

FIG. 16 shows a schematic view of another embodient of a diversion member of the present invention.

FIG. 17 shows a schematic view of still another embodient of a diversion member of the present invention.

FIG. 18 shows a driving circuit diagram of the present invention.

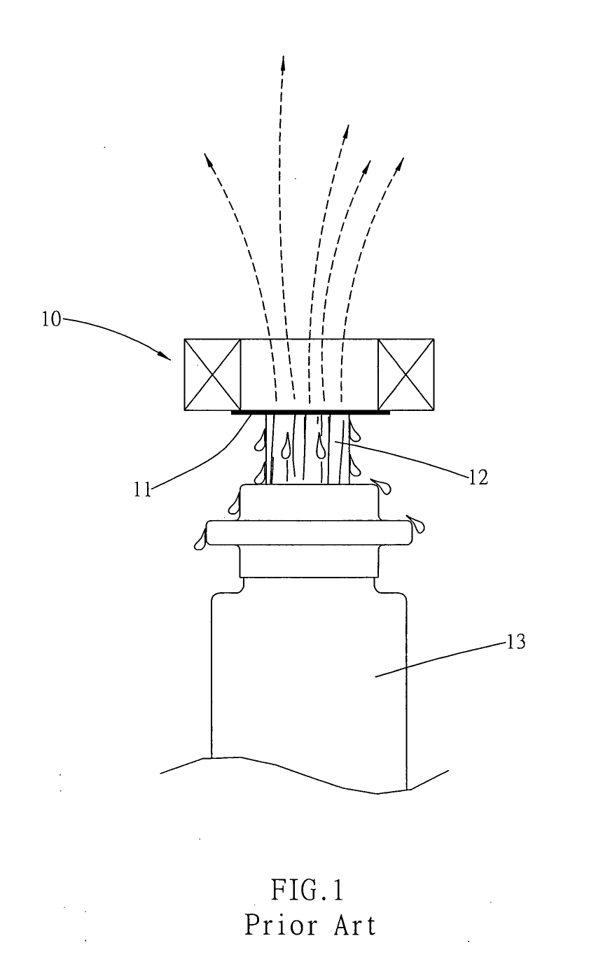

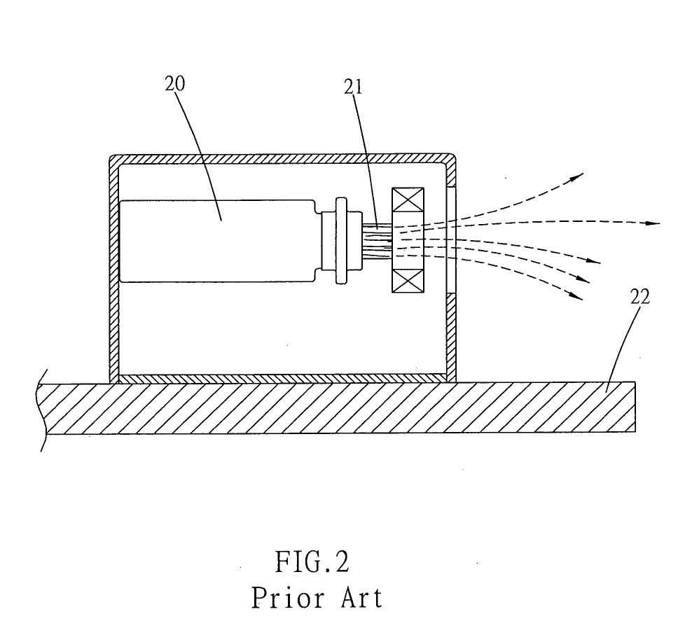

### DETAILED DESCRIPTION OF THE PREFERRED EMBODIMENTS

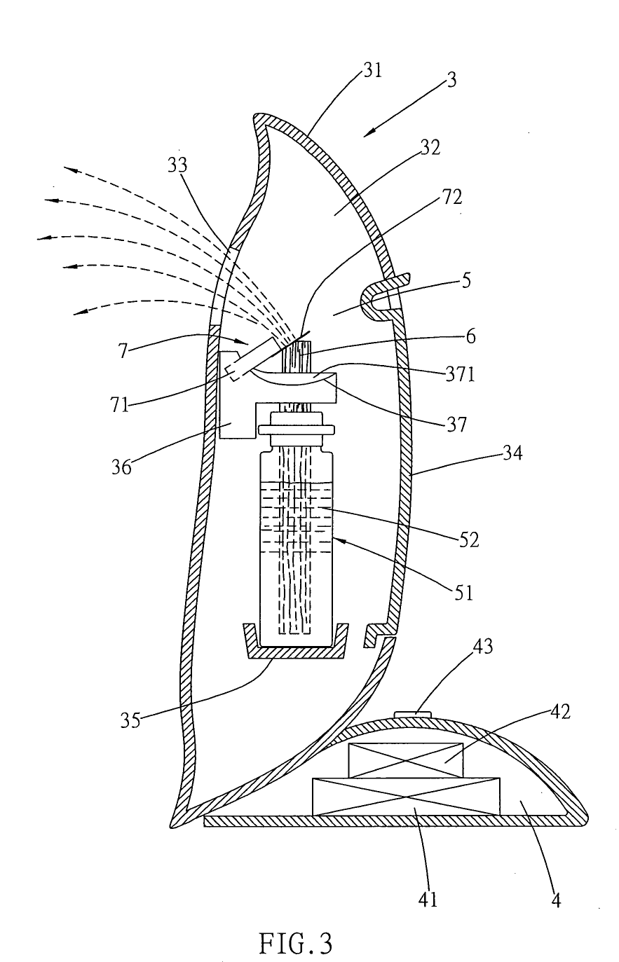

Referring to FIG. 3, a spraying structure for an atomizer of the present invention comprises a main body 3, a power part 4, and a set of spraying device 5. An exterior surface of the main body 3 is provided with a housing 31 in a proper shape, which can be latched by a plurality of boards facing oppositely, to facilitate being opened for use. An interior of the housing 31 is formed with a containing space 32 to stably emplace the spraying device 5. A surface of the housing 31 is provided with an opening 33 and a cover plate 34 which can be opened at any time. In addition, the main body 3 is assembled with the power part 4, and an interior of which is provided with a power source 41 (either AC or DC), a driving circuit 42, and a control switch 43.

The aforementioned spraying device 5 is primarily composed of a vertically installed liquid container 51 with its opening facing upward. The liquid container 51 is positioned by a latching seat 35, and is kept upright. An interior of the liquid container 51 contains a working fluid 52 which can be a liquid medicine or aromatics. A liquid delivery member 6 is located at an exit above the liquid container 51, and can be a liquid absorbing fiber or cotton core, which is used primarily to suck out the working fluid within the liquid container 51, and is therefore preferably made by a material of soft cotton core or with a capillary effect.

A vibration member 7 is composed of a cubical-shape piezoelectric ceramic actuator 71 which is assembled with a vibratory plate 72 by a suspension method. An end of the vibratory plate 72 is connected to the actuator 71, and a surface of the vibratory plate 72 is provided with tiny actuation holes. By the suspension method, the vibratory plate 72 can be formed into a bare shape to completely develop vibration energy. In addition, there will be no other staining mechanism for possible residual liquid to be easily drained, due to the bare-plate shape of the vibratory plate 72. Besides, as the vibration wave is accumulated at the bare-shape vibratory plate 72, the possibly stained liquid will completely receive the vibration wave to be forced to release; therefore, the suspension method can prevent the residual liquid from being attached.

The vibration member 7 is fixed slantingly by a suspension seat 36 which is installed in an interior of the main body 3. After the vibration member 7 is assembled and fixed, its actuation surface will be specifically in contact with a surface at a corner end on a top of the liquid delivery member 6, in a tilted direction; wherein a cross section of the liquid delivery member 6 can be physically a circular shape or any geometric shape. In addition, an end of the suspension seat 36 is extended with a recovery device 37, which is surrounded on a periphery of the liquid delivery member 6 and the vibration member 7, and a surface at an upper end of which is formed with a collection slot 371 being concaved inward and downward. The actuator 71 and the vibratory plate 72 are assembled with the suspension method, and can be linearly assembled on a same plane. Accordingly, the actuator 71 is also installed slantingly in an interior of the housing 31, with respect to a top of the recovery device 37, thereby allowing the residual liquid coming from the vibratory plate 72 or the liquid delivery member 6 to flow down along a tilted and downward direction.

To accomplish the aforementioned functions, a longitudinal line of the actuator 71 can be also made to be vertical to a ground surface and to be parallel to the container, and the vibratory plate 72 should be bended to form a tilted relation with respect to the actuator 71.

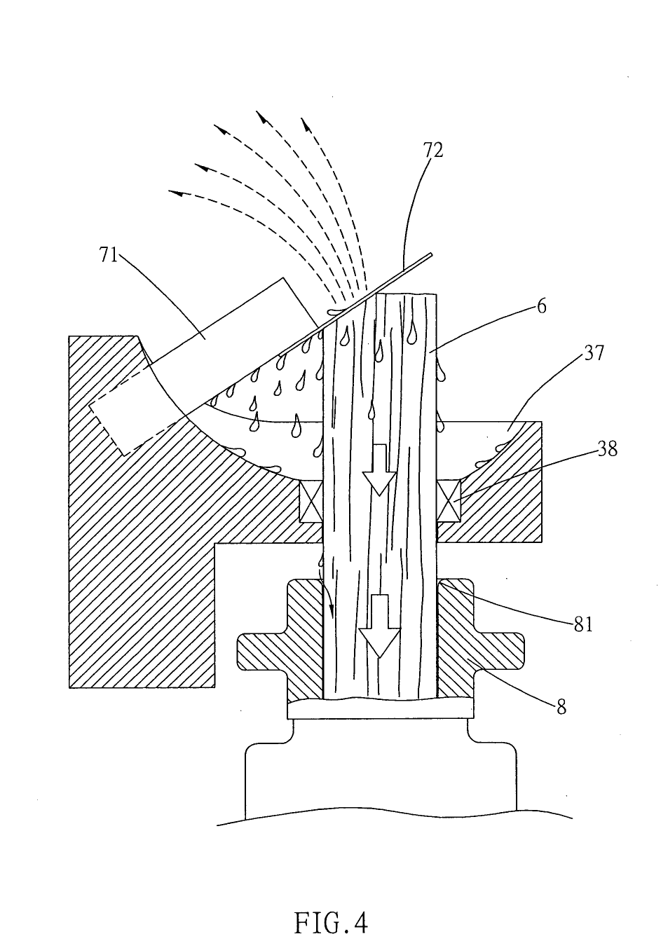

Referring to FIG. 4, after the aforementioned structures are assembled, and while using the present invention, as the vibratory plate 72 is in contact with the corner of liquid delivery member 6, when the vibratory plate 72 is driven by a high frequency vibration of the actuator 71, the liquid membrane on the surface of liquid delivery member 6 will be actuated and atomized to form the mists, by a contact of the tiny actuation holes on its surface with the liquid delivery member 6 in high frequency vibration. As the vibratory plate 72 is installed slantingly, the sprayed mists are moving along a parabolic curve, with an end point of the parabolic curve being easily arranged on a same horizontal line with a position of spraying, which can be viewed as spraying laterally as a whole. It is naturally that an accuracy of spraying orientation should be dependent on requirement and be in cooperation with the structural configuration. However, the object of spraying laterally of present invention is primarily to provide the spraying vector which is in lateral with respect to the main body, so as to facilitate an implementation of hanging the spraying structure on a wall. In addition, from a principle of Brownian motion, it is known that as the droplets of mists after being sprayed can be very fine, they can be floating in air; therefore, the atomized droplets can be quickly diffuse to the atmosphere.

By using the tilted contact of present invention, the aforementioned advantages can be available; and using the tilted positioning, the vibratory plate 72 can be kept as clean as the aperture of actuation holes. Therefore, under a specified condition, the liquid can be uniformly atomized, and during the process of spraying, the exterior surface of housing can be kept clean due to that the mist droplets can be carried by ambient air to release from the housing in time, because of their uniformity.

After the liquid is actuated by the high frequency vibration of vibratory plate 72, the excessive liquid will return back along the vibratory plate 72 due to the tilted surface, and then flow into the collection slot 371 of recovery device 37 at a lower end of the vibratory plate 72, to be prevented from leaking out. In addition, a part of the liquid membrane formed at an entire upper end head of the liquid delivery member 6 that is not in contact with the opposite face of the vibratory plate 72 will not be actuated, and the non-actuated liquid membrane will be accumulated into liquid drops, resulting from the effect of vibration wave and the compensation of capillary effect, to overflow downward due to an effect of gravitational force. The overflowed drops can be recovered through the collection slot 371.

As shown in the drawings, a sheathing member 38 can be installed at a middle section of the contact position between the recovery device 37 and the liquid delivery member 6. The sheathing member 38 is a ring which is made by a liquid absorbing material, and can be attached to an outer circumference of the liquid delivery member 6 to form the capillary effect for holding a large amount of returned liquid, and to form a mutual compensation with the liquid delivery member 6.

Through the aforementioned structures, most of the residual liquid can be recovered, whereas an exterior surface of the liquid delivery member 6 below the recovery device 37 can also be possibly provided with a small amount of accumulated liquid. A recovery seal cap 8 is located between the liquid delivery member 6 and the container 51, and is covered on a top end of the liquid container 51. By an arc-shape corner 81 at a contact end between the recovery seal cap 8 and the liquid delivery member 6, the small amount of down-streaming liquid can be affined to a surface of the liquid delivery member 6 and be absorbed into a core of the liquid delivery member 6, which will in turn be returned back to the container.

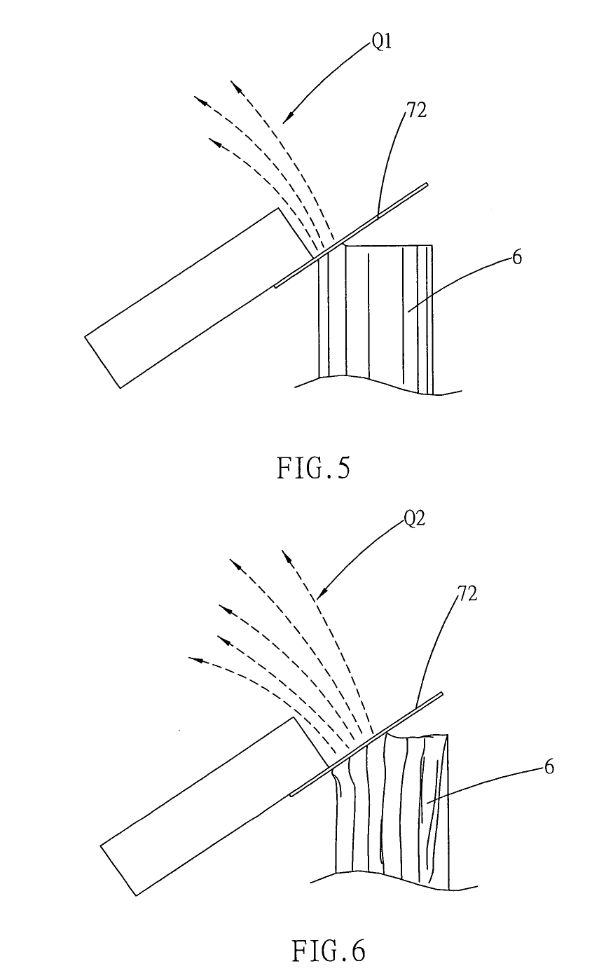

Referring to FIG. 5, by the tilted contact of vibratory plate 72 with the corner end of liquid delivery member 6, the amount of mists to be sprayed can be determined by a contact area between the vibratory plate 72 and the liquid delivery member 6. As shown in the drawing, when the vibratory plate 72 is only in contact with a sharp corner of the liquid delivery member 6, the amount of mists to be sprayed Q1 will be smaller due to that the contact area of reaction is smaller. As shown in FIG. 6, when the vibratory plate 72 is deeply in contact with a larger corner of the liquid delivery member 6, the amount of mists to be sprayed Q1 will be correspondingly increased due to that the contact area is enlarged. To be in compliance with the condition of atomization mass, the actuation power of aforementioned vibratory plate 72 can be adjusted by a circuit.

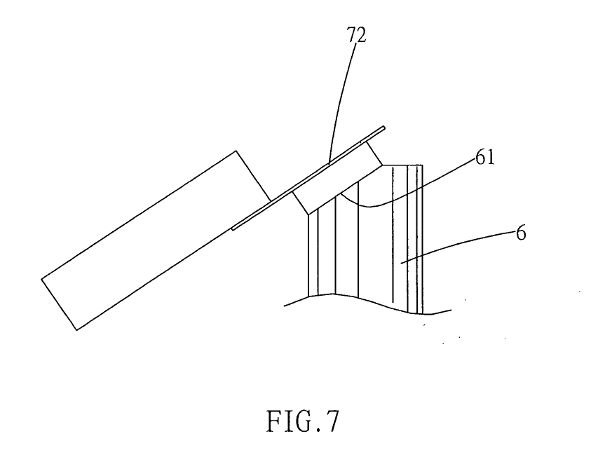

Referring to FIG. 7, if the large amount of mists to be sprayed is required inherently, a predetermined inclined plane 61 can be cut out at an upper end head of the liquid delivery member 6 relative to the contact position of the vibratory plate 72, in advance. A slope of the inclined plane 61 is equal to a specified slope of the vibratory plate 72, and hence is parallel affixed to the vibratory plate 72. With a larger inclined area from the cut corner end, a larger liquid membrane will be formed to provide the vibratory plate 72 with a larger source of workload, thereby developing larger mists, so as to result in a spraying of large amount of mists toward a front.

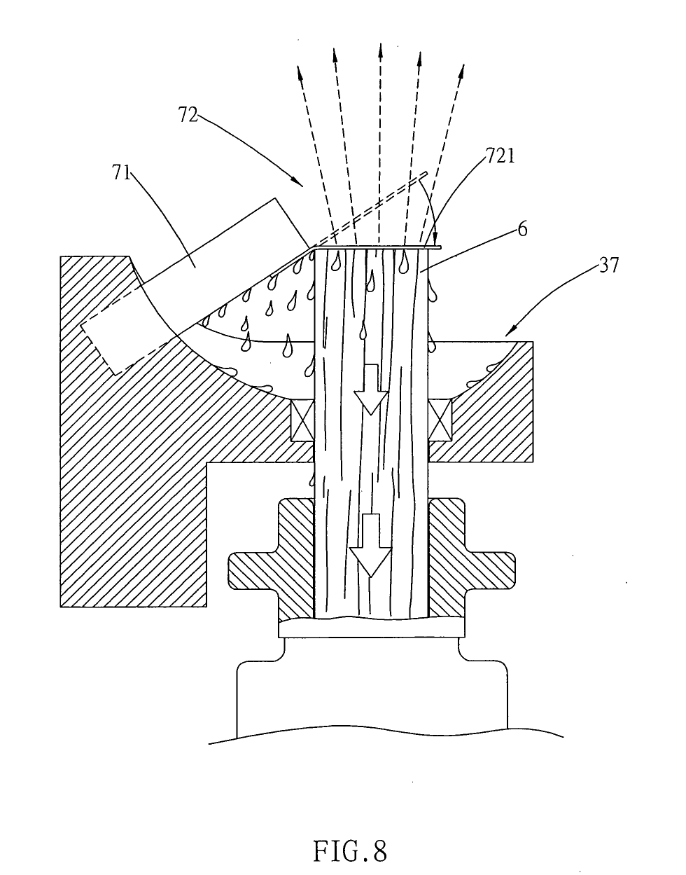

Referring to FIG. 8, when the vibratory plate 72 is slantingly configured, its front vibration part 721 can be in a bended shape. Therefore, according to circumstances of application, the vibration part 721 can be bended into a horizontal shape and is completely in contact with an upper end surface of the liquid delivery member 6, so as to form a vertical spraying; wherein the residual liquid resulting from external factors are easily scattered and released due to that the vibration part 721 is in a bare shape. In addition, the liquid drops which are overflowed to an exterior of the piezoelectric ceramic actuator 71 can be also recovered in a tilted direction, by the recovery device for reuse, due to that the surface of piezoelectric actuator is tilted.

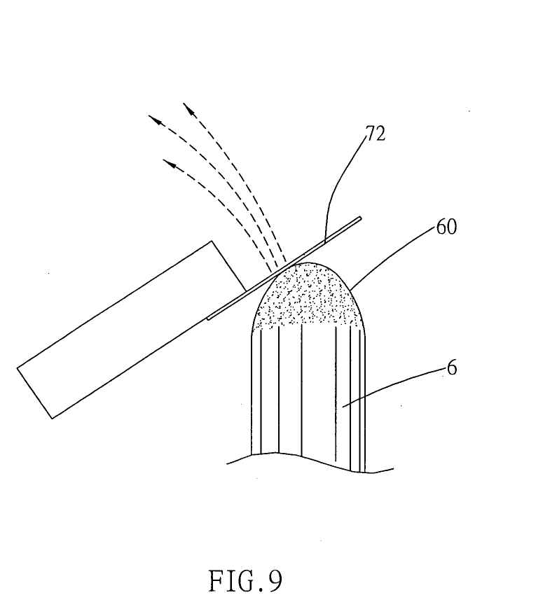

Referring to FIG. 9, to solve a problem that the corner end of liquid delivery member 6 can be deviated in a mass production, or to facilitate arranging an installation angle of the vibratory plate 72, the upper end of the liquid delivery member 6 is set to be a cylindrical body 60. By a means of its arc line in tangential to a flat reaction surface of the vibratory plate 72, a constant circumferential area can be obtained, thereby achieving a constant atomization, even that there is a relative change of orientation for the liquid delivery member 6 and the vibratory plate 72. On the other hand, referring to FIG. 5 and FIG. 6, by a change of depth, the actuation amount can be further adjusted. A same power of the aforementioned vibratory plate 72 is used to meet the requirement.

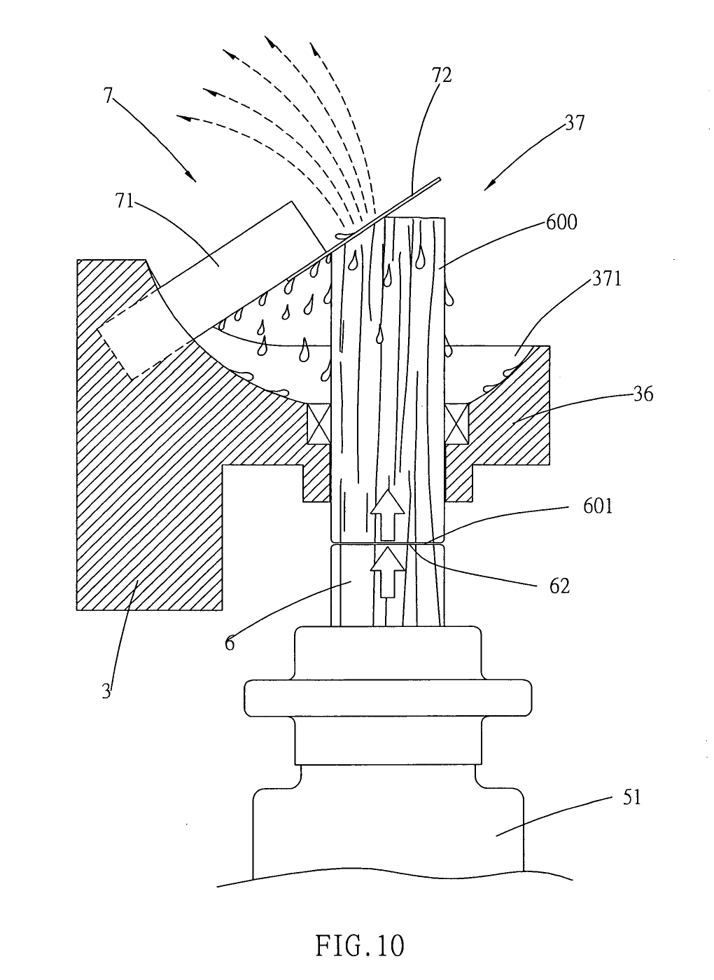

The present invention further provides an independent diversion member in a path between the liquid delivery member and the vibratory plate. By an introduction of the diversion member, the opening of liquid delivery member of liquid container can be conveniently positioned at a high, low location or any orientation, to effectively expel the liquid. Therefore, a precision for positioning the container can be neglected, which is relatively convenient to a simple latching-type installation. In addition, a certain contact pressure can be maintained for the vibratory plate and the diversion member, so as to achieve a constant actuation of mists. Referring to FIG. 10, a spraying structure is still composed of the vibration member 7 which is connected to the main body 3. The vibration member 7 includes the actuator 71 which drives the vibratory plate 72. An independent diversion member 600 is connected by pressing an actuation surface relative to the vibratory plate 72, and the other end of the diversion member 600 in formed into a coupling interface 601; therefore, the diversion member 600 can be taken as being fixed on the main body 3. As shown in the drawing, the suspension seat 36 can be used as a support to fix the diversion member 600 at a certain condition, such that a certain degree of abutting force will be achieved for an upper end of the diversion member 600 and the vibratory plate 72; whereas the coupling interface 600 at lower end can provide for a coupling with other object, for example, the upper end opening 62 of liquid delivery member 6 can be oppositely connected at different pressure.

Accordingly, by the introduction of independent diversion member 600, in replacing the container 51, the upper end opening 62 of liquid delivery member 6 can be connected with the coupling interface 601 installed by the diversion member 600, at any close proximity, such that the precision for positioning the container 51 can be neglected. On the other hand, the ordinary container 51 is latched into the device by bare hands, the container body is made by a glass, the size of product changes widely, and some containers can be usually loosened without falling out after being latched in. However, in the present invention, a certain amount of contact pressure with the vibratory plate is maintained at one end of the liquid delivery member; therefore, there is no need to intentionally adjust the position.

In principle, during an operation of replacing the liquid container 51, it is only required that the upper end opening 62 is in contact with the coupling interface 601, to enable the liquid which is sucked up by the liquid delivery member 6 to be in contact with the coupling interface 601, and the assembly pressure between the end opening 62 and the coupling interface 601 is not important. As the diversion member 600 has been already fixed at a certain position of the main body 3, its upper end opening and the vibratory plate 72 have acquired the predetermined constant shear stress; therefore, after the container 51 is positioned for being assembled with the end opening of liquid delivery member 6, the working fluid can be absorbed by the coupling interface 601 indirectly. This method provides a wide flexibility in a high, low location of positioning the container 51, and enables the vibration member 7 to produce a stable amount of atomization.

If the diversion member 600 of present invention is implemented on the suspension seat 36 as shown in the drawings, an upper end surface of the suspension seat 36 is provided with a recovery device 37 which also contains a collection slot 371, in order to divert the possible residual liquid to the diversion member 600, thereby accomplishing the object of recovering.

According to a requirement of target tools to be used, the diversion member 600 can be vertical to a ground surface. Therefore, to an application of the recovery device 37, the residual liquid can be recovered. After the large amount of residual liquid is recovered, they will be returned back to the liquid delivery member 6 through the coupling interface 601, and then the saturated liquid will be returned back to the container 51 by the liquid delivery member 6, thereby accomplishing the complete recovery of the residual liquid, so as to prevent a staining to the ambient environment or an unnecessary loss.

The diversion member 600 can be fixed on the main body 3 by locking with any hardware measure, or by a clipping force of the structures. Basically, the diversion member 600 is a single body having a capillary function, and can be made by any material having the capillary function.

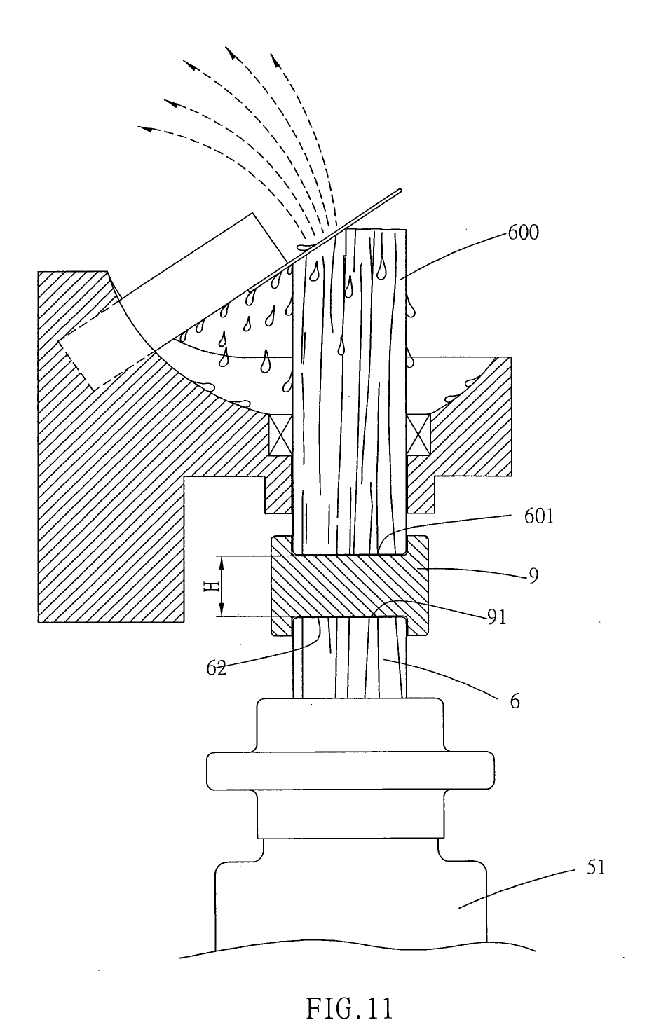

Referring to FIG. 11, after the diversion member 600 is fixed on the main body 3, in order to have the coupling interface 601 to be connected with the container 51 with a wider flexibility of coupling position, or to allow the coupling interface 601 to provide a connection for the liquid delivery member 6 with multiple kinds of end opening 62, a buffering bridge member 9 is indirectly introduced. In principle, the buffering bridge member 9 is connected at the coupling interface 601, and a suction surface 91 at a lower end of the buffering bridge member 9 can provide the end opening 62 of liquid delivery member 6 installed by the container 51 with a flexible choice of positioning location of the container 51 within a range of height H, and can even transmit a large quantity of liquid. Basically, the buffering bridge member 9 is an elastic body, which can be made by a liquid absorption capillary material, such as an ordinary high density sponge. It is naturally that the buffering bridge member 9 can be assembled with the coupling interface 601 by any measures, or by a same measure as with the main body 3.

The container 51 can be positioned with a same mechanical structure as with the main body 3.

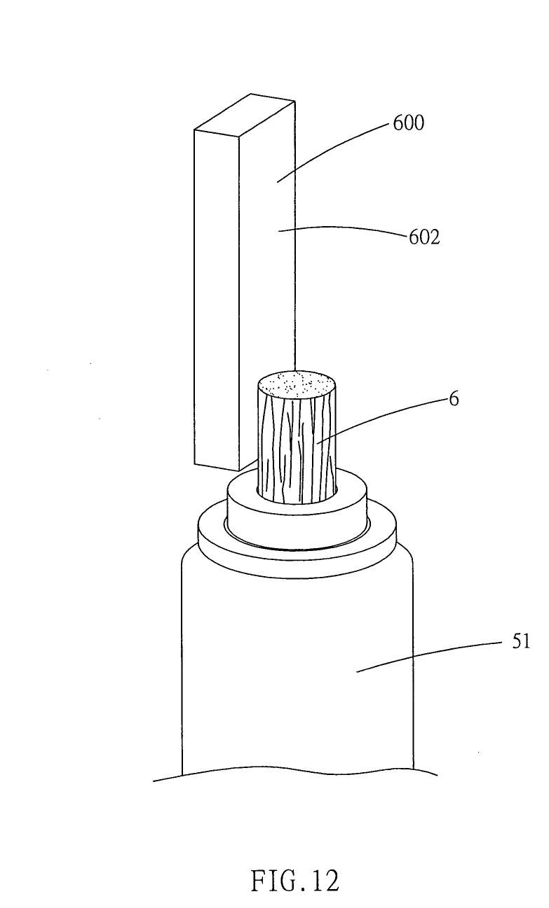

Referring to FIG. 12, the diversion member 600 of present invention basically uses its lower end surface as a guiding; whereas the other embodient relies on a requirement of target object. For example, if the container 51 needs to be latched in transversally, the liquid delivery member 6 can form a lateral abutting surface 602. The abutting surface 602 can provide a shear stress at a longitudinal exterior surface of the liquid delivery member 6 of the container 51. After that, the liquid will be transmitted to the diversion member 600 through the capillary effect, as usual. By guiding with the lateral shear stress, during the process of linking and positioning the container 51, the high, low positioning location of the liquid delivery member 6 can have a wider choice.

Referring to FIG. 13, in another embodient of the diversion member 600, a lower end is opened with an inward indentation 603 which is basically provided with an appearance similar to that of an upper end of the liquid delivery member 6 of container 51. The inward indentation 603 enables the liquid delivery member 6 to be positioned in a radial (transversal) direction. This lateral positioning method is also dependent on a requirement of target object. Referring to FIG. 13, the container 51 is replaced according to the requirement of being transversally positioned.

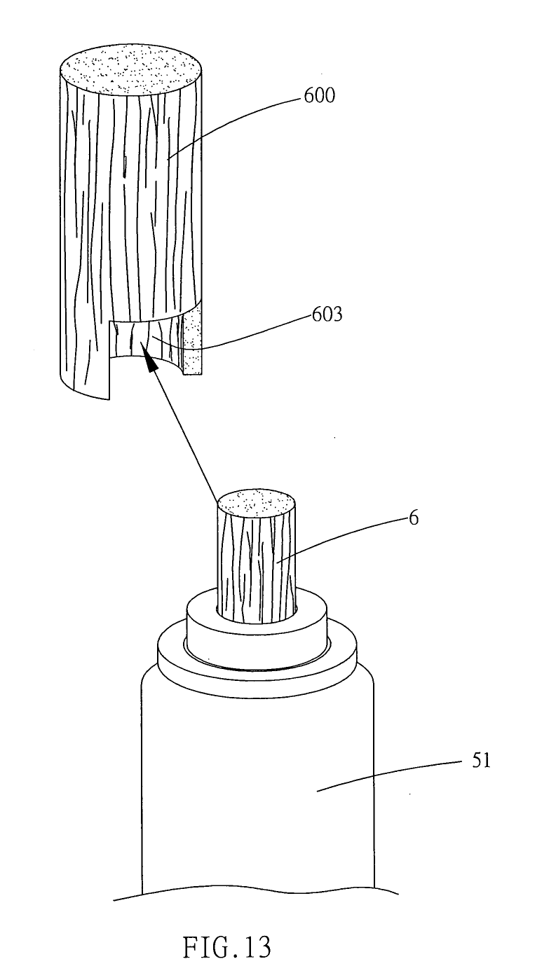

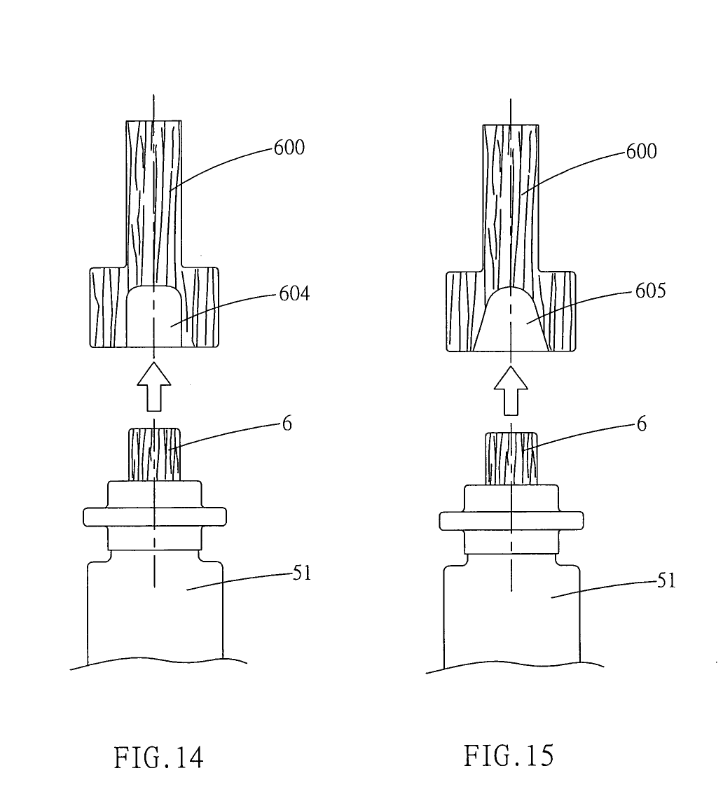

Referring to FIG. 14, in order to allow the diversion member 600 to have a larger absorption capacity, a latching slot 604 can be located axially at its lower end. The latching slot 604 allows the liquid delivery member 6 of container 51 to be coupled axially, such that an upper end of the liquid delivery member 6 can be extended into the latching slot 604. Correspondingly, a periphery of the liquid delivery member 6 can be assembled onto an inner wall of the latching slot 604, thereby enabling a transmission of a larger amount of the liquid.

Referring to FIG. 15, according to the structure which is coupled axially, a lower end of the diversion member 600 can be opened with a cone-shape slot 605 axially. The cone-shape slot 605 provides the liquid delivery member 6 of container 51 to be latched in axially, and a corner end of the liquid delivery member 6 can be abutted on or pressed into an inclined plane of the cone-shape slot 605, where a tight connection will be formed by pressing the corner end to an extremity, provided that the liquid can be transmitted.

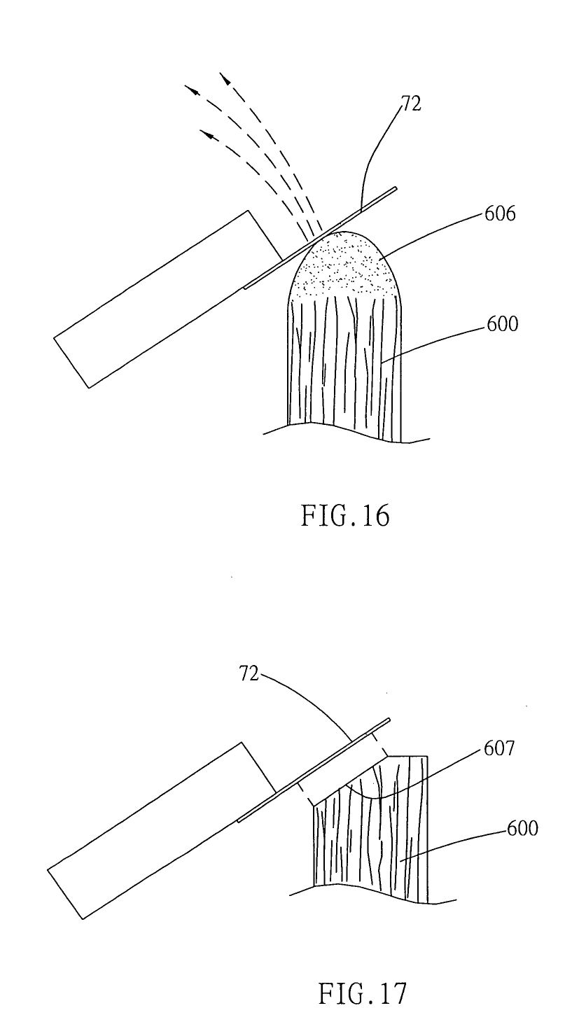

Referring to FIG. 16, an upper end of the diversion member 600 can be formed with a cylindrical shape 606, corresponding to the method for resulting in the shear stress on the vibratory plate 72. A point-wise shear stress contact can be formed by an arc line of the cylinder 606 and an actuation surface of the vibratory plate 72, which enables the vibratory plate 72 to keep at actuating a smaller amount of mists.

Referring to FIG. 17, in order to allow the vibratory plate 72 to have a larger amount of atomization, an upper end of the diversion member 600, relative to an actuation surface of the vibrator plate, is parallel and symmetrically opened with an inclined plane 607, with its area being used to determine an increase of the amount of atomization, thereby generating a certain amount of large liquid for the vibratory plate 72 to actuate a large amount of stable mists.

The aforementioned diversion member 600 is affixed on the vibratory plate 72 by abutting, so as to provide the liquid membrane formed to the vibratory plate 72 for actuating. It is naturally that the magnitude of contact pressure between the vibratory plate 72 and the diversion member 600 will change the amount of atomization, with its requirement being able to be adjusted based on the condition of target object, or with a change of working frequency or power of the vibratory plate; both of which can adjust the quantity of atomization.

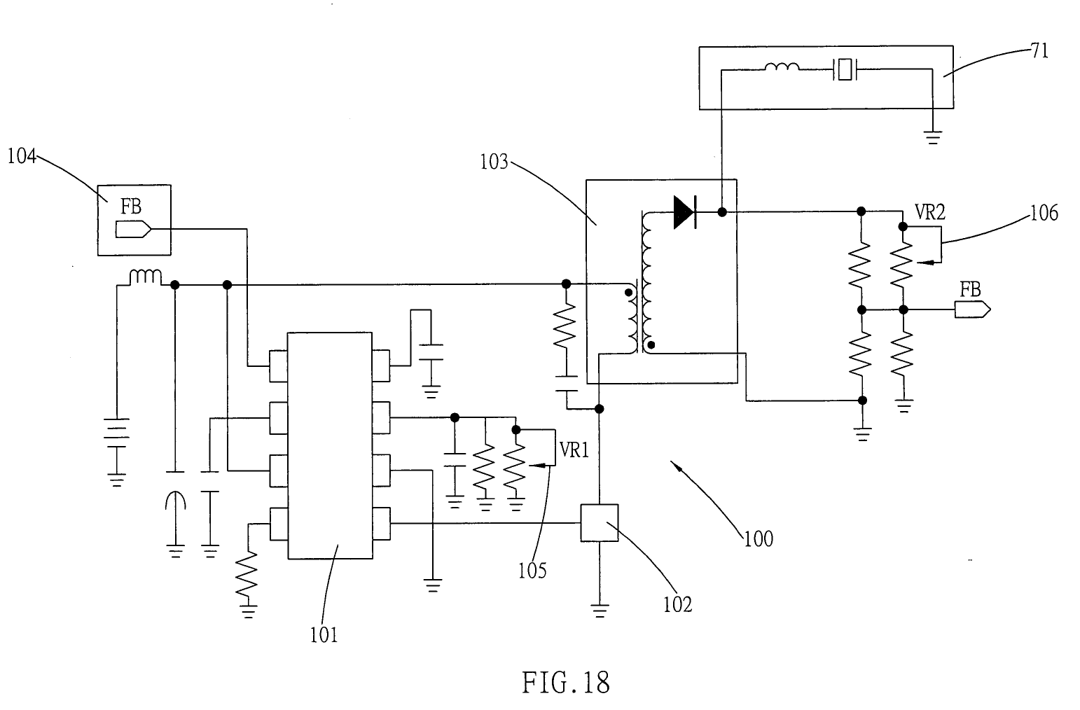

Referring to FIG. 18, a driving circuit 100 of the present invention comprises a microprocessor unit 101, a driving unit 102, a voltage-boosting unit 103, and a feedback unit 104; which is used to drive the aforementioned actuator 71 of the vibration member 7 to generate vibration.

The aforementioned microprocessor unit 102 provides a PWM (Pulse Width Modulation) signal output. An input end of the driving unit 102 is connected with an output end of the aforementioned microprocessor unit 101, and after the PWM signal provided by the microprocessor unit 101 is received, a driving signal will be outputted. The voltage-boosting unit 103 includes a transformer or a piezoelectric ceramic, and its input end is connected with an output end of the aforementioned driving unit 102 to boost up the voltage, so as to drive the actuator (ceramic piece) 71 to generate the vibration. The feedback unit 102 is connected between the actuator 71 and the microprocessor unit 101, and the microprocessor unit 101 will determine a duty cycle of output clock based on an average current of the actuator 71 which is detected through the feedback unit (current feedback) 104, thereby controlling the average current of the actuator 71.

When the driving circuit 100 is operating, the microprocessor unit 101 will output a PWM signal to drive the driving unit 102 to operate, thereby enabling the voltage-boosting unit 103 to increase the voltage. After the voltage is increased, the actuator 71 will be driven to generate the vibration, and the vibratory plate 72 will be driven to operate, which results in an atomization to the liquid membrane which is located on the vibratory plate 72, and is coming from the liquid delivery member 6.

As the present invention uses the PWM signal and a transformer to carry out an impedance conversion, the operating voltage can be as low as 1.8 V_{DC}. In addition, by using the feedback method to detect the output power, and using the constant voltage, the circuit can automatically modulate based on a change of load (the actuator 71), such that the output can be a constant. On the other hand, the circuit structure can be sustained with a change of ±50% of voltage, and can still maintain a stable output, thereby providing a even wider range of application.

In the mean time, using the duty cycle to modulate the output power is different from the ordinary method of using a driving voltage to modulate the power; which will be even more stable, more power saving, and can achieve a satisfied amount of atomization under a loss of total power of 0.4 W.

Furthermore, in performing a damping factor conversion from using the transformer, the driving circuit 100 can be completely in cooperation with a static capacity of the ceramic piece (the actuator 71), such that the shape of vibration wave can be closer to a sine wave, thereby completely eliminating an interference of EMI (Electro-Magnetic Impulse).

Moreover, a first modulation unit 105 and a second modulation unit 106 can be added to the circuit, wherein the first and second modulation units 105, 106 are constituted by variable resistors. The aforementioned first modulation unit 105 can adjust the working frequency freely, whereas the second modulation unit 106 can adjust the output power freely.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A spraying structure for an atomizer comprising a main body which is provided with an opening for forming a channel of spraying mists, a power part, and a spraying device; the main body being provided with the spraying device which takes the required power from the power part; the spraying device including a vibration member which is constituted by an actuator and a vibratory plate, and which is used to vibrate a liquid membrane sucked up from a surface of a liquid delivery member for atomizing; the aforementioned liquid delivery member being vertical to a ground surface along its longitudinal direction, and the vibratory plate being slantingly in contact with an upper end of the liquid delivery member for actuating.

2. The spraying structure for an atomizer according to claim 1, wherein a periphery of the aforementioned liquid delivery member is surrounded by a recovery device, and an upper end of the recovery device is formed with a collection slot pointed to the liquid delivery member.

3. The spraying structure for an atomizer according to claim 2, wherein the collection slot of the aforementioned recovery device is extended to a lower part of the vibration member, so as to guide the liquid which is returned along the vibratory plate to flow toward the liquid delivery member.

4. The spraying structure for an atomizer according to claim 1, wherein a power of the aforementioned vibration member is adjusted through a circuit which is a PWM (Pulse Width Modulation)-type circuit.

5. The spraying structure for an atomizer according to claim 1, wherein an upper end of the liquid delivery member is in a cylindrical shape.

6. A spraying structure for an atomizer comprising a main body, a power part, and a spraying device; the main body being provided with the spraying device which takes the required power from the power part, the spraying device including a vibration member which is constituted by an actuator and a vibratory plate, and which is used to vibrate a liquid membrane sucked up from a surface of a liquid delivery member for atomizing; a periphery of the aforementioned liquid delivery member being surrounded by a recovery device, and an upper end of the aforementioned recovery device being formed with a collection slot pointed to the liquid delivery member.

7. The spraying structure for an atomizer according to claim 6, wherein the aforementioned recovery device is distributed and extended to a lower part of the vibration member.

8. A spraying structure for an atomizer, especially a spraying structure which actuates mists by high frequency vibration, comprising a vibration member which is constituted by a piezoelectric ceramic assembled with a vibratory plate, and which is assembled at a corner of the main body, as a whole; an independently and vertically arranged diversion member being located at a working side relative to the vibratory plate, in order to suck up the working fluid indirectly, an end of the diversion member being in contact with the aforementioned working side of the vibratory plate, and the other end of diversion member being formed with a coupling interface.

9. The spraying structure for an atomizer according to claim 8, wherein the diversion member and the vibration member are assembled together at a suspension seat installed by the main body.

10. The spraying structure for an atomizer according to claim 8, wherein the coupling interface installed by the diversion member is axially connected with a buffering bridge member.

11. The spraying structure for an atomizer according to claim 8, wherein an end of the diversion member is a flat abutting surface.

12. The spraying structure for an atomizer according to claim 8, wherein an end of the diversion member is provided with an inward indentation.

13. The spraying structure for an atomizer according to claim 8, wherein an end of the diversion member is inward provided with a latching slot, along an axis direction.

14. The spraying structure for an atomizer according to claim 13, wherein the latching slot is a cone-shape slot.

15. The spraying structure for an atomizer according to claim 8, wherein an end of the diversion member which is in contact with the vibratory plate is in a cylindrical shape.

16. The spraying structure for an atomizer according to claim 8, wherein a periphery of the diversion member is surrounded by a recovery device, and an upper end of which is formed with a collection slot pointed to the diversion member.

17. The spraying structure for an atomizer according to claim 8, wherein the vibratory plate is slantingly in contact with an upper end of the diversion member.
